(19) United States
(12) Patent Application Publication
(10) Pub. No.: US 2010/0239910 A1
(43) Pub. Date: Sep. 23, 2010

(54) NON-AQUEOUS ELECTROLYTE SECONDARY BATTERY

(75) Inventors: Shingo Tode, Naruto-shi (JP); Katsuaki Takahashi, Kobe-shi (JP); Yoshinori Kida, Kobe-shi (JP); Hiroyuki Fujimoto, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/728,688

(22) Filed: Mar. 22, 2010

(30) Foreign Application Priority Data
Mar. 23, 2009 (JP) 2009-69498
Jun. 30, 2009 (JP) 2009-155016

(51) Int. Cl. H01M 4/52

(52) U.S. Cl. 429/223

(57) ABSTRACT

A non-aqueous electrolyte secondary battery including a positive electrode having a positive electrode mixture layer containing a positive electrode active material, a binder, and a conductive agent, and a negative electrode having a negative electrode active material capable of intercalating and deintercalating lithium. The positive electrode active material includes a layered lithium-transition metal composite oxide represented by the compositional formula LiₐNiₓM₍₁₋ₓ₎O₂ where 0<a≦1.1, 0.5<X≦1.0, and M is at least one element. The binder contains a fluororesin and a nitrile-based polymer. The amount of the nitrile-based polymer is 40 mass % or less with respect to the total amount of the binder.

### BACKGROUND OF THE INVENTION

1. Field of the Invention

The present invention relates to a non-aqueous electrolyte secondary battery using a positive electrode active material comprising a layered lithium-transition metal composite oxide having nickel as its main component, and more particularly to a non-aqueous electrolyte secondary battery having excellent high-rate discharge performance.

2. Description of Related Art

Mobile information terminal devices such as mobile telephones, notebook computers, and PDAs have become smaller and lighter at a rapid pace in recent years. This has led to a demand for higher capacity batteries as the drive power source for the mobile information terminal devices. With their high energy density and high capacity, non-aqueous electrolyte secondary batteries, which perform charge and discharge by transferring lithium ions between the positive and negative electrodes, have been widely used as a driving power source for the mobile information terminal devices.

As the mobile information terminal devices tend to have greater numbers of functions, such as moving picture playing functions and gaming functions, the power consumption of the devices tends to increase. It is therefore strongly desired that the non-aqueous electrolyte secondary batteries used for the power sources of such devices have further higher capacities and higher performance to achieve longer battery life and improved output power. In addition, it is expected that the non-aqueous electrolyte secondary batteries are used for not just the above-described applications but to power tools, power assisted bicycles, and HEVs. In order to meet such demand, it is also strongly desired that the non-aqueous electrolyte secondary batteries have further higher capacity and lighter weight.

In order to provide a non-aqueous electrolyte secondary battery with a higher energy density, it is necessary to use a positive electrode active material that has a high energy density. In view of this, it has been proposed to use a positive electrode active material composed of a composite oxide in which a transition metal such as cobalt or nickel is contained in solid solution in the main active material, lithium. In this case, depending on the type of the transition metal used, the electrode shows varying electrode characteristics such as capacity, reversibility, operating voltage, and safety.

One example of the composite oxide in which a transition metal is contained in solid solution in lithium is LiCoO₂. However, when more than half of the lithium is extracted from LiCoO₂ (i.e., when x becomes greater than 0.5 in Li₁₋ₓCoO₂) in the case where LiCoO₂ is used as the positive electrode active material, the crystal structure degrades and the reversibility deteriorates. Therefore, the usable discharge capacity density with LiCoO₂ is about 160 mAh/g, and it is difficult to further increase the energy density.

In view of the problem, it has been proposed to use a R-3m rhombohedral layered rocksalt type composite oxide employing nickel as the main material, such as LiNi_{0.8}Co_{0.2}O₂. The specific capacity of the composite oxide is from 180 mAh/g to 200 mAh/g, which is greater than LiCoO₂. Therefore, a higher energy density can be achieved.

For example, Japanese Patent No. 2971451 proposes a lithium secondary battery having a positive electrode active material including a lithium-containing transition metal composite oxide represented by the compositional formula LiNi₁₋ₓMₓO₂ (where M is one or more elements, and 0<x≦0.5), and using an acrylic rubber copolymer and a polyvinylidene fluoride-based fluororesin as the binder agents.

However, our study of the battery that employs a positive electrode active material composed of such a layered lithium-transition metal composite oxide using nickel as the main transition metal has revealed that the battery shows a higher impedance during charge and poorer high-rate discharge performance than the battery employing the above-mentioned LiCoO₂.

Japanese Published Unexamined Patent Application No. 2007-194202 discloses a lithium ion secondary battery that employs a positive electrode active material containing either a lithium-cobalt composite oxide represented by LiₐCo₁₋ₓMeₓO_{2-b} (wherein Me is at least one, or two or more, metal elements selected from V, Cu, Zr, Zn, Mg, Al, and Fe, 0.9≦a≦1.1, 0≦x≦0.3, and −0.1≦b≦0.1) or a lithium-nickel-cobalt-manganese composite oxide represented by the general formula LiₐNi_{1-x-y-z}CoₓMn_{y}Me_{z}O_{2-b} (wherein Me is at least one, or two or more, metal elements selected from V, Cu, Zr, Zn, Mg, Al, and Fe, 0.9≦a≦1.1, 0≦x≦0.3, 0<y<0.4, 0<z<0.3, and −0.1≦b≦0.1), and the binder contains a polyacrylonitrile-based resin.

However, when lithium cobalt oxide is used as the positive electrode active material, the advantageous effects such as mentioned above are not obtained, but rather the impedance during charge becomes higher and the high-rate discharge performance degrades. The reason is as follows. Unlike the foregoing positive electrode active material, lithium cobalt oxide shows smaller volumetric change resulting from the charge-discharge reactions. As a consequence, when a nitrile-based polymer is used as a binder in the case of using lithium cobalt oxide as the positive electrode active material, the resistance within the positive electrode increases because the nitrile-based polymer itself has high resistance.

In the proposal shown in Japanese Patent No. 2971451, the binder agent used along with polyvinylidene fluoride-based fluororesin is an acrylic rubber copolymer. In the case of using such a rubbery binder agent, each positive electrode active material particle is covered with the rubbery binder agent. As a consequence, the impedance during charge becomes high, and the high-rate discharge performance degrades. Another problem with using a rubbery binder agent is that the viscosity of the positive electrode active material slurry that is used when preparing the positive electrode becomes high, resulting in poor coatability of the positive electrode active material slurry.

Japanese Published Unexamined Patent Application No. 2007-194202 does not show the technical idea that the high-rate discharge performance is significantly improved in a battery that employs a positive electrode active material comprising a layered lithium-transition metal composite oxide containing nickel as the main transition metal, by restricting the amount of the nitrile-based polymer to be 40 mass % or less with respect to the total amount of the binder.

### BRIEF SUMMARY OF THE INVENTION

Accordingly, it is an object of the present invention to provide a non-aqueous electrolyte secondary battery that shows a low impedance during charge and excellent high-rate discharge performance while achieving a high capacity, and moreover prevents the degradation in coatability.

In order to accomplish the foregoing and other objects, the present invention provides a non-aqueous electrolyte secondary battery comprising: a negative electrode having a negative electrode active material capable of intercalating and deintercalating lithium; and a positive electrode having a positive electrode mixture layer containing a positive electrode active material, a binder, and a conductive agent, the positive electrode active material comprising a layered lithium-transition metal composite oxide represented by the compositional formula LiₐNiₓM₍₁₋ₓ₎O₂ where 0<a≦1.1, 0.5<X≦1.0, and M is at least one element, and the binder containing a fluororesin and a nitrile-based polymer, wherein the amount of the nitrile-based polymer is 40 mass % or less with respect to the total amount of the binder.

It should be noted that the term “nitrile-based polymer” as used in the present specification is not meant to include a polymer that contains a rubbery substance represented by the following Chemical Formula (I) in its structural formula.

—(CH₂—CH═CH—CH₂)ₙ— Chemical Formula (I)

Here, the layered lithium-transition metal composite oxide represented by the above compositional formula has a high capacity, but it shows a large volumetric change due to charge-discharge reactions. In addition, fluororesin such as polyvinylidene fluoride, which is commonly used as a binder, has weak binding capability. Consequently, if a battery (or a positive electrode) is produced using the foregoing composite oxide and fluororesin, the conductivity between the positive electrode active material and the conductive agent as well as the conductivity between the positive electrode active material and the current collector will be low. In view of the problem, a nitrile-based polymer, which has good binding capability, is added to the binder. This can prevent the conductivity between the positive electrode active material and the conductive agent as well as the conductivity between the positive electrode active material and the current collector from degrading, even when the volumetric change of the active material during charge and discharge is large. As a result, a conductive path within the positive electrode is maintained, so the impedance during charge is kept low and the high-rate discharge performance is prevented from deteriorating. Moreover, the nitrile-based polymer used in the present invention does not contain a rubbery substance. Therefore, the deterioration of the high-rate discharge performance resulting from the rubbery substance is also minimized. Furthermore, the viscosity of the positive electrode active material slurry does not increase, so the problem of poor coatability of the slurry can be avoided.

The amount of the nitrile-based polymer is restricted to be 40 mass % or less with respect to the total amount of the binder. The reason is that when the amount of the nitrile-based polymer exceeds 40 mass %, the impedance becomes high in a charged state, degrading the high-rate discharge performance. It is believed that, because the nitrile-based polymer itself has high resistance, the problem associated with the high resistance of the nitrile-based polymer itself becomes more significant than the advantage of maintaining the above-described conductive path.

Thus, in the case of using a positive electrode active material that shows a large volumetric change due to charge-discharge reactions, the advantage of maintaining the conductive path within the positive electrode overcomes the problem of the high resistance of the nitrile-based polymer itself. On the other hand, in the case of using a positive electrode active material that shows a small volumetric change due to charge-discharge reactions, the advantage of maintaining the conductive path within the positive electrode is minute and the problem of the high resistance of the nitrile-based polymer itself becomes evident.

The present invention makes it possible to obtain a high capacity battery while reducing the impedance during charge and improving the high-rate discharge performance by preventing a decrease in conductivity within the positive electrode, even in the case of using a positive electrode active material that shows a large volumetric change due to charging.

### BRIEF DESCRIPTION OF THE DRAWINGS

FIG. 1 is a graph illustrating the alternating current impedance profiles during charge of Batteries A1 to A3 of the invention and Comparative Battery X1;

FIG. 2 is a graph illustrating the alternating current impedance profiles during charge of Comparative Batteries X2 to X5; and

FIG. 3 is a graph illustrating the alternating current impedance profiles during charge of Batteries A3 and A4 of the invention as well as Comparative Battery X1.

### DETAILED DESCRIPTION OF THE INVENTION

A non-aqueous electrolyte secondary battery according to the present invention comprises: a negative electrode having a negative electrode active material capable of intercalating and deintercalating lithium; and a positive electrode having a positive electrode mixture layer containing a positive electrode active material, a binder, and a conductive agent, the positive electrode active material comprising a layered lithium-transition metal composite oxide represented by the compositional formula LiₐNiₓM₍₁₋ₓ₎O₂ where 0<a≦1.1, 0.5<X≦1.0, and M is at least one element, and the binder containing a fluororesin and a nitrile-based polymer, wherein the amount of the nitrile-based polymer is 40 mass % or less with respect to the total amount of the binder.

It is desirable that the lithium-transition metal composite oxide be represented by the compositional formula LiₐNiₓM₍₁₋ₓ₎O₂, where 0<a≦1.1, 0.5<X≦1.0, and M is at least one element selected from the group including Co, Mn, Al, Mg, and Cu.

It is desirable that the amount of the nitrile-based polymer be 8 mass % or greater with respect to the total amount of the binder.

If the amount of the nitrile-based polymer is 8 mass % or less with respect to the total amount of the binder, the advantageous effects resulting from adding the nitrile-based polymer may not be exhibited sufficiently.

It is desirable that the amount of the nitrile-based polymer be 1 mass % or less with respect to the total amount of the positive electrode mixture layer.

If the amount of the nitrile-based polymer exceeds 1 mass % with respect to the total amount of the binder, the problem of the high resistance of the nitrile-based polymer becomes evident, and the impedance becomes high in a charged state, degrading the high-rate discharge performance.

It is desirable that the amount of the binder be 5 mass % or less with respect to the total amount of the positive electrode mixture layer.

If the amount of the binder exceeds 5 mass % with respect to the total amount of the binder, the problem of the high resistance of the nitrile-based polymer becomes evident, and in addition, the amount of the positive electrode active material per unit area becomes less, lowering the capacity density of the battery.

It is desirable that the nitrile-based polymer comprise a polymer having a unit containing (meth)acrylonitrile. It is desirable that the nitrile-based polymer be polyacrylonitrile, and the fluororesin be polyvinylidene fluoride.

It should be noted however that the polymer unit is not limited to (meth)acrylonitrile, but it may be, for example, carboxylic ester.

### Other Embodiments

(1) The negative electrode active material used in the present invention is not particularly limited as long as it can reversibly intercalate and deintercalate lithium. Examples include carbon materials, metal or alloy materials that can be alloyed with lithium, and metal oxides. From the viewpoint of material cost, it is preferable to use a carbon material as the negative electrode active material. Examples include natural graphite, artificial graphite, mesophase pitch-based carbon fiber (MCF), mesocarbon microbead (MCMB), coke, hard carbon, fullerene, and carbon nanotube. From the viewpoint of improvement in high-rate charge-discharge capability, it is particularly preferable to use a carbon material in which a graphite material is covered with a low crystallinity carbon.

(2) The non-aqueous solvent used for the non-aqueous electrolyte may be any known non-aqueous solvent that is commonly used for non-aqueous electrolyte secondary batteries. Examples include cyclic carbonates such as ethylene carbonate, propylene carbonate, butylene carbonate and vinylene carbonate, and chain carbonates such as dimethyl carbonate, methyl ethyl carbonate, and diethyl carbonate. In particular, it is preferable to use a mixed solvent of a cyclic carbonate and a chain carbonate as a non-aqueous solvent having a low viscosity, a low melting point, and high lithium ion conductivity. In this mixed solvent, it is preferable that the volume ratio of the cyclic carbonate and the chain carbonate be from 2:8 to 5:5.

(3) It is also possible to use an ionic liquid as the solvent for the non-aqueous electrolyte. When this is the case, the cationic species and the anionic species are not particularly limited; however, it is preferable to use a combination in which the cation is pyridinium cation, imidazolium cation, and quaternary ammonium cation, and the anion is fluorine-containing imide-based anion, from the viewpoints of obtaining low viscosity, electrochemical stability, and hydrophobicity.

(4) The solute used for the non-aqueous electrolyte may be any known lithium salt that is commonly used as a solute in non-aqueous electrolyte secondary batteries. Such a lithium salt may be a lithium salt containing at least one element among P, B, F, O, S, N, and Cl. Examples of the lithium salt include LiPF₆, LiBF₄, LiCF₃SO₃, LiN(CF₃SO₂)₂, LiN(C₂F₅SO₂)₂, LiN(CF₃SO₂)(C₄F₉SO₂), LiC(C₂F₅SO₂)₃, LiAsF₆, and LiClO₄, and mixtures thereof. It is particularly preferable to use LiPF₆, in order to enhance the high-rate charge-discharge capability and durability of the non-aqueous electrolyte secondary battery.

(5) The separator interposed between the positive electrode and the negative electrode may be made of any material as long as it can prevent the short circuiting resulting from contact between the positive electrode and the negative electrode and it can obtain lithium ion conductivity when being impregnated with a non-aqueous electrolyte solution. Examples include a polypropylene separator, a polyethylene separator, and a polypropylene-polyethylene multi-layered separator.

Hereinbelow, preferred embodiments of the non-aqueous electrolyte secondary battery according to the present invention are described in detail. It should be construed, however, that the non-aqueous electrolyte secondary battery according to this invention is not limited to the following embodiments and examples, and that various changes and modifications are possible without departing from the scope of the invention.

### Preparation of Positive Electrode

First, LiOH and a coprecipitated hydroxide represented as Ni_{0.78}Co_{0.19}Al_{0.03}(OH)₂ were mixed so that the mole ratio of lithium to the whole of the transition metals became 1.02:1. Thereafter, the mixture was sintered at 750° C. for 20 hours in an oxygen atmosphere and thereafter pulverized, to thus obtain a positive electrode active material represented as LiNi_{0.78}Co_{0.19}Al_{0.03}O₂.

Next, polyacrylonitrile (PAN) and polyvinylidene fluoride (PVdF) as binder agents (binder) were dissolved in N-methyl-2-pyrrolidone as a dispersion medium. Then, the positive electrode active material obtained in the above-described manner and carbon as a conductive agent were prepared, and subsequently, the positive electrode active material, the conductive agent, PAN, and PVdF were mixed together so that the mass ratio thereof became 95:2.5:0.2:2.3, respectively. Thereafter, the mixture was kneaded to prepare a positive electrode slurry. Next, the positive electrode slurry was applied onto an aluminum foil as a current collector and thereafter dried to form a positive electrode mixture layer. Thereafter, the resultant material was calendered with pressure rollers, and a positive electrode current collector tab was attached thereto. Thus, a positive electrode was prepared.

In the just-described positive electrode, the amount of the PAN is determined to be 8.0 mass % with respect to the total amount of the binder (PAN+PVdF) from the following equation (1).

[0.2/(0.2+2.3)]×100=8.0 mass % (1)

### Preparation of Negative Electrode

First, to an aqueous solution in which carboxymethylcellulose as a thickening agent was dissolved in water, artificial graphite as a negative electrode active material and styrene-butadiene rubber as a binder agent were added so that the mass ratio of the negative electrode active material, the binder agent, and the thickening agent was 97.5:1.5:1. Thereafter, the resultant mixture was kneaded to produce a negative electrode slurry. Next, the resultant negative electrode slurry was applied onto a copper foil serving as a current collector, and then dried to form a negative electrode mixture layer.

The resultant material was then calendered with pressure-rollers, and a current collector tab was attached thereto. Thus, a negative electrode was prepared.

### Preparation of Electrolyte Solution

First, lithium hexafluorophosphate (LiPF₆) was dissolved at a concentration of 1.2 mol/L into a solvent in which ethylene carbonate (EC), methyl ethyl carbonate (MEC), and diethyl carbonate (DEC) were mixed at a volume ratio of 2:5:3. Thereafter, vinylene carbonate (VC) was added thereto so that the amount of VC was 2.0 mass with respect to the total amount of the electrolyte solution. Thus, an electrolyte solution was prepared.

### Preparation of Battery

First, the positive electrode and the negative electrode prepared in the above-described manner were wound together so that they oppose each other across a separator interposed therebetween, to prepare a wound electrode assembly. The wound electrode assembly and the electrolyte solution were then sealed into an aluminum laminate battery case in a glove box under an argon atmosphere. Thus, a non-aqueous electrolyte secondary battery before aging was obtained (battery standard size: 3.6 mm thick×3.5 cm wide×6.2 cm long, nominal capacity: 800 mAh).

The just-described battery before aging was charged at a constant current of 800 mA (1.0 It) for 10 minutes at room temperature and then aged for 15 hours in a thermostatic chamber at 60° C. The battery was then cooled at room temperature and thereafter charged at a constant current 800 mA (1.0 It) until the voltage reached 4.2 V, and further charged at a constant voltage of 4.2 V until the current value reached 40 mA (0.05 It). Thereafter, the battery was discharged at a constant current of 800 mA (1.0 It) until the voltage reached 2.5 V. Thus, a non-aqueous electrolyte secondary battery was prepared.

In the non-aqueous electrolyte secondary battery, the amounts of the positive and negative electrode active materials were determined so that the charge capacity ratio of the positive electrode and the negative electrode (charge capacity of the negative electrode/charge capacity of the positive electrode) became 1.05 at the portion where the electrodes oppose each other in the case that the end-of-charge voltage was 4.2 V. In all the following examples and comparative examples, the charge capacity ratio of the positive and negative electrodes was the same.

### EXAMPLES

### First Example Group

### Example 1

A non-aqueous electrolyte secondary battery was fabricated according to the same manner as the just-described embodiment. The non-aqueous electrolyte secondary battery fabricated in this manner is hereinafter referred to as Battery A1 of the invention.

### Example 2

A non-aqueous electrolyte secondary battery was fabricated in the same manner as described in Example 1 above, except that in preparing the positive electrode, the active material, the conductive agent, PAN, and PVdF were mixed so that the mass ratio thereof became 95:2.5:0.34:2.16, respectively. It should be noted that in the positive electrode of this non-aqueous electrolyte secondary battery, the amount of PAN is 13.6 mass % with respect to the total amount of the binder.

The non-aqueous electrolyte secondary battery fabricated in this manner is hereinafter referred to as Battery A2 of the invention.

### Example 3

A non-aqueous electrolyte secondary battery was fabricated in the same manner as described in Example 1 above, except that in preparing the positive electrode, the active material, the conductive agent, PAN, and PVdF were mixed so that the mass ratio thereof became 95:2.5:1.0:1.5, respectively. It should be noted that in the positive electrode of this non-aqueous electrolyte secondary battery, the amount of PAN is 40.0 mass % with respect to the total amount of the binder.

The non-aqueous electrolyte secondary battery fabricated in this manner is hereinafter referred to as Battery A3 of the invention.

### Example 4

A non-aqueous electrolyte secondary battery was fabricated in the same manner as described in Example 1 above, except that in preparing the positive electrode, the active material, the conductive agent, polyacrylonitrile (PAN)-methylacrylate copolymer (the amount of PAN being about 94 mass %), and PVdF were mixed so that the mass ratio thereof became 95:2.5:0.34:2.16, respectively.

The non-aqueous electrolyte secondary battery fabricated in this manner is hereinafter referred to as Battery A4 of the invention. It should be noted that in the positive electrode of this non-aqueous electrolyte secondary battery, the amount of the copolymer is 13.6 mass % with respect to the total amount of the binder.

### Comparative Example 1

A non-aqueous electrolyte secondary battery was fabricated in the same manner as described in Example 1 above, except that in preparing the positive electrode, PAN was not added, and the active material, the conductive agent, and PVdF were added so that the mass ratio thereof became 95:2.5:2.5, respectively.

The non-aqueous electrolyte secondary battery fabricated in this manner is hereinafter referred to as Comparative Battery X1.

### Comparative Example 2

A non-aqueous electrolyte secondary battery was fabricated in the same manner as described in Example 1 above except for the following. In preparing the positive electrode, Li₂CO₃, Co₃O₄, ZrO₂, MgO, and Al₂O₃ were used, and these materials were mixed together in an Ishikawa-type Raikai mortar so that the mole ratio of Li, Co, Zr, Mg, and Al became 100:97.8:0.2:1.0:1.0. Thereafter, the mixture was sintered in an air atmosphere at 850° C. for 24 hours, and then pulverized to prepare a positive electrode active material represented as LiCo_{0.978}Zr_{0.002}Mg_{0.01}Al_{0.01}O₂. In addition, in preparing the electrolyte solution, ethylene carbonate (EC), methyl ethyl carbonate (MEC), and diethyl carbonate (DEC) were mixed at a volume ratio of 3:6:1, respectively.

The non-aqueous electrolyte secondary battery fabricated in this manner is hereinafter referred to as Comparative Battery X2.

### Comparative Example 3

A non-aqueous electrolyte secondary battery was fabricated in the same manner as described in Comparative Example 2 above, except that in preparing the positive electrode, the active material, the conductive agent, PAN, and PVdF were mixed so that the mass ratio thereof became 95:2.5:0.2:2.3, respectively. It should be noted that in the positive electrode of this non-aqueous electrolyte secondary battery, the amount of PAN is 8 mass % with respect to the total amount of the binder. The non-aqueous electrolyte secondary battery fabricated in this manner is hereinafter referred to as Comparative Battery X3.

### Comparative Example 4

A non-aqueous electrolyte secondary battery was fabricated in the same manner as described in Comparative Example 2 above, except that in preparing the positive electrode, the active material, the conductive agent, PAN, and PVdF were mixed so that the mass ratio thereof became 95:2.5:0.34:2.16, respectively. It should be noted that in the positive electrode of this non-aqueous electrolyte secondary battery, the amount of PAN is 13.6 mass % with respect to the total amount of the binder. The non-aqueous electrolyte secondary battery fabricated in this manner is hereinafter referred to as Comparative Battery X4.

### Comparative Example 5

A non-aqueous electrolyte secondary battery was fabricated in the same manner as described in Comparative Example 2 above, except that in preparing the positive electrode, the active material, the conductive agent, PAN, and PVdF were mixed so that the mass ratio thereof became 95:2.5:1.0:1.5, respectively. It should be noted that in the positive electrode of this non-aqueous electrolyte secondary battery, the amount of PAN is 40.0 mass % with respect to the total amount of the binder.

The non-aqueous electrolyte secondary battery fabricated in this manner is hereinafter referred to as Comparative Battery X5.

In each of Batteries A1 to A4 of the invention and Comparative Batteries X1 to X5 fabricated in the above-described manners, the amount of PAN with respect to the total amount of the positive electrode mixture layer and the amount of PAN with respect to the total amount of the binder were as shown in Table 1 below. In Table 1 hereinbelow, LiNi_{0.78}Co_{0.19}Al_{0.03}O₂ is abbreviated as LNCA and LiCo_{0.978}Zr_{0.002}Mg_{0.01}Al_{0.01}O₂ is abbreviated as LCO.

TABLE 1

| | Positive | Amount of PAN or PAN | | Amount of PAN or PAN | |
|---|---|---|---|---|---|
| | electrode | copolymer in positive | | copolymer in total | |
| | active | electrode mixture | | amount of binder | |
| Battery | material | (mass %) | | (mass %) | |
| X1 | LNCA | 0 | | 0 | |
| A1 | | 0.20 | (PAN) | 8.0 | (PAN) |
| A2 | | 0.34 | (PAN) | 13.6 | (PAN) |
| A3 | | 1.00 | (PAN) | 40.0 | (PAN) |
| A4 | | 0.34 | (PAN copolymer) | 13.6 | (PAN copolymer) |
| X2 | LCO | 0 | | 0 | |
| X3 | | 0.20 | (PAN) | 8.0 | (PAN) |
| X4 | | 0.34 | (PAN) | 13.6 | (PAN) |
| X5 | | 1.00 | (PAN) | 40.0 | (PAN) |

### Experiment

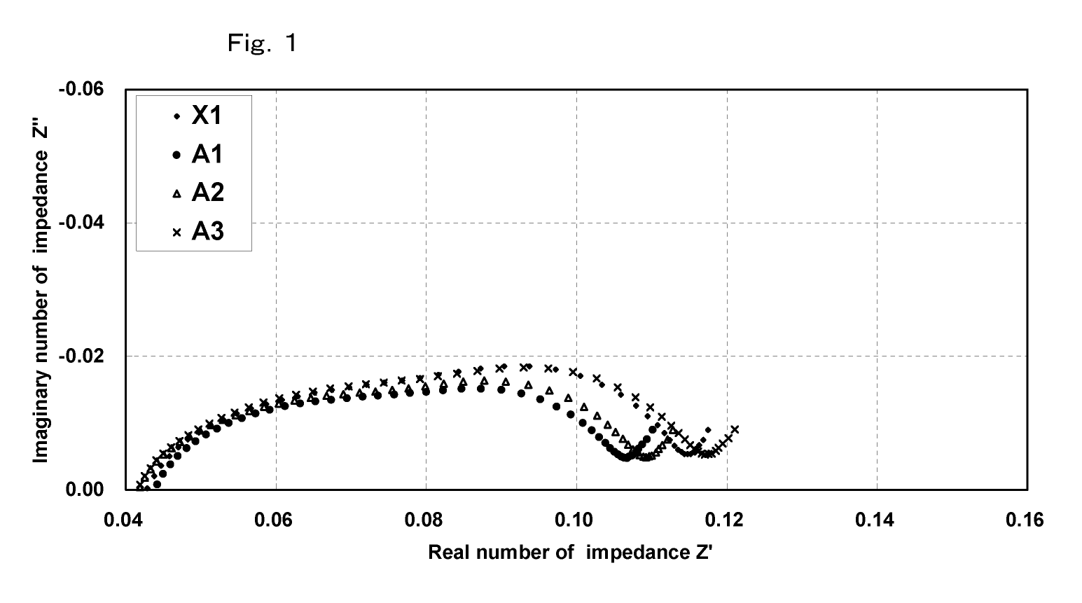

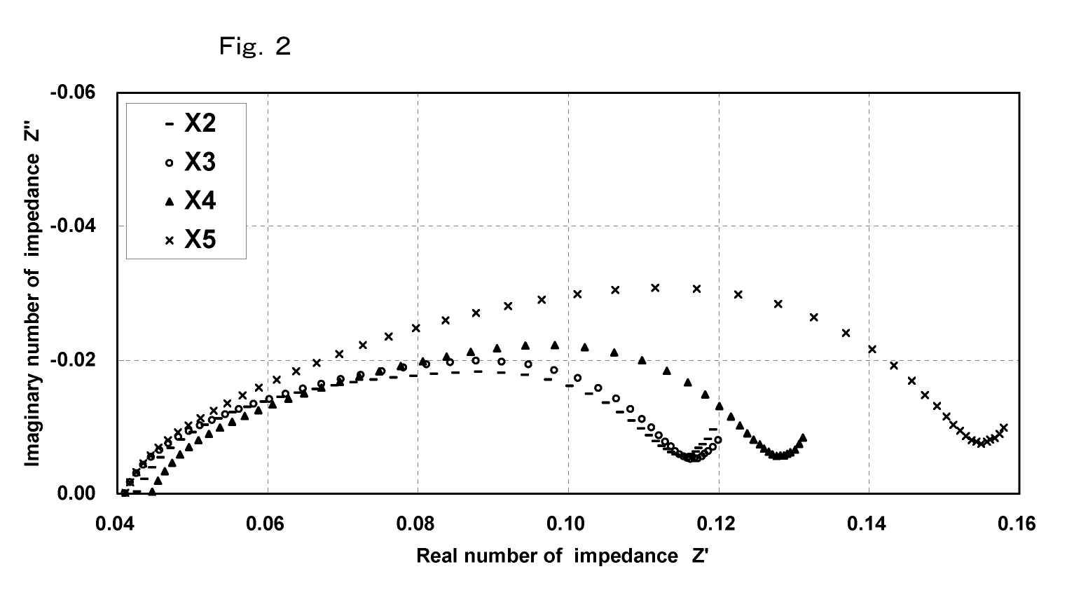

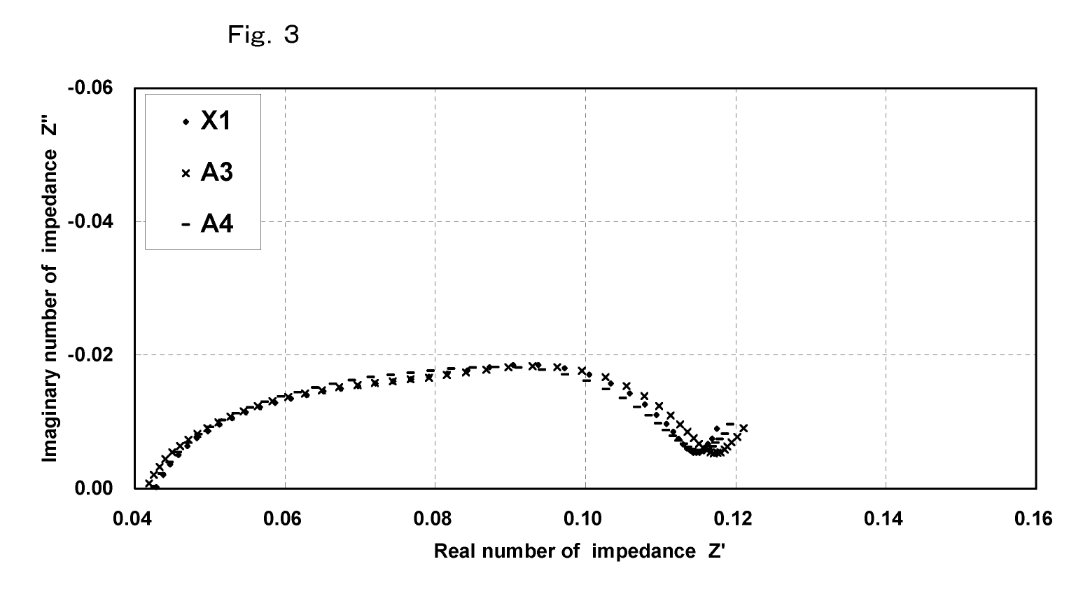

The alternating current impedance profiles were determined for Batteries A1 to A4 of the invention and Comparative Batteries X1 to X5 in the following method. The results are shown in FIGS. 1 to 3. The alternating current impedance profiles for Batteries A1 to A3 and Comparative Battery X1, which use LNCA as the positive electrode active material, are shown in FIG. 1. The alternating current impedance profiles for Comparative Batteries X2 to X5, which use LCO as the positive electrode active material, are shown in FIG. 2.

### [Alternating Current Impedance Profile Test Method]

Each of the batteries was charged at a constant current of 800 mA (1.0 It) until the voltage reached 4.2 V and further charged at a constant voltage of 4.2 V until the current value reached 40 mA (0.05 It). Thereafter, the alternating current impedance (cole-cole plot) was measured for each battery by applying a voltage of 10 mV in the range of 10 kHz to 100 mHz.

As clearly seen from FIGS. 1 to 3, when the amount of PAN is greater, the curve of the impedance measurement result is larger for Comparative Batteries X2 to X5 that used LCO (a lithium-transition metal composite oxide that has a layered structure but does not contain nickel as a transition metal) as the positive electrode active material. On the other hand, when the amount of PAN is greater, the curve of the impedance measurement result is rather smaller for Batteries A1 to A3 of the invention and Comparative Battery X1, which use LNCA as the positive electrode active material (in comparison between Batteries A1 and A2, in which the amounts of PAN are 8.0 mass and 13.6 mass %, respectively, with respect to the total amount of the binder, and Comparative Battery X1, in which the binder does not contain PAN). Battery A3 of the invention, in which the amount of PAN is 40.0 mass % with respect to the total amount of the binder, Battery A4 of the invention, in which the amount of polyacrylonitrile (PAN)-methylacrylate copolymer is 13.6 mass % with respect to the total amount of the binder, and Comparative Battery X1, in which the binder does not contain PAN, showed almost the same curve of the impedance measurement result.

From the foregoing results, it will be appreciated that the effect of reducing impedance resulting from the addition of PAN is exhibited only when LNCA is used as the positive electrode active material, and the effect is not observed when LCO is used as the positive electrode active material.

It will also be appreciated that it is necessary to control the amount of PAN with respect to the total amount of the binder to be 40.0 mass % or less when PAN is added in the battery that uses LNCA as the positive electrode active material. As clearly seen from FIG. 1, it is believed that when the amount of PAN with respect to the total amount of binder exceeds 40.0 mass %, the impedance will be higher than that of Comparative Battery X1, in which the binder does not contain PAN.

### Second Example Group

### Comparative Example

A non-aqueous electrolyte secondary battery was fabricated in the same manner as described in Example 1 of the First Example Group except for the following. In preparing the positive electrode active material, Li₂CO₃, Co₃O₄, ZrO₂, MgO, and Al₂O₃ were used, and these materials were mixed together in an Ishikawa-type Raikai mortar so that the mole ratio of Li, Co, Zr, Mg, and Al became 100:97.8:0.2:1.0:1.0. Thereafter, the mixture was sintered in an air atmosphere at 850° C. for 24 hours, and then pulverized to prepare a positive electrode active material made of LCO. In addition, in preparing the positive electrode, PAN was not added, and the active material, the conductive agent, and PVdF were added so that the mass ratio thereof became 95:2.5:2.5, respectively.

The non-aqueous electrolyte secondary battery fabricated in this manner is hereinafter referred to as Comparative Battery Y.

### Experiment

The high-rate discharge performance was determined for Batteries A1 to A4 of the invention and Comparative Batteries X1 and Y using the following method. The results are shown in Table 2 below.

### [High-Rate Discharge Performance Test Method]

Each of the batteries was charged at a constant current of 800 mA (1.0 It) until the voltage reached 4.2 V and then further charged at a constant voltage of 4.2 V until the current value became 40 mA (0.05 It). Thereafter, each battery was discharged at a constant current of 800 mA (1.0 It) until the battery voltage reached 2.5 V.

Thereafter, each battery was charged again in the same charge conditions as described above. Then, each battery was discharged at constant currents of 1600 mA (2.0 It), 2400 mA (3.0 It), and 3200 mA (4.0 It) until the battery voltage reached 2.5 and the discharge capacity at each current was obtained to determine the discharge rate ratio at each current using the following equation (2).

Discharge rate ratio (%)=(Discharge capacity at each current/Discharge capacity at 800 mA)×100 (2)

TABLE 2

| | Positive | Amount of PAN or | | Amount of PAN or | | High-rate discharge performance | | |
|---|---|---|---|---|---|---|---|---|
| | electrode | PAN copolymer in | | PAN copolymer in | | (Discharge rate ratio) | | |
| | active | positive electrode | | total amount of | | 1600 mA | 2400 mA | 3200 mA |
| Battery | material | mixture (mass %) | | binder (mass %) | | (%) | (%) | (%) |
| X1 | LNCA | 0 | | 0 | | 77.3 | 44.4 | 27.5 |
| A1 | | 0.20 | (PAN) | 8.0 | (PAN) | 87.3 | 55.9 | 35.9 |
| A2 | | 0.34 | (PAN) | 13.6 | (PAN) | 87.7 | 55.4 | 36.0 |
| A3 | | 1.00 | (PAN) | 40.0 | (PAN) | 83.0 | 49.9 | 31.3 |
| A4 | | 0.34 | (PAN copolymer) | 13.6 | (PAN copolymer) | 89.3 | 53.9 | 30.6 |

| | | | | | | |
|---|---|---|---|---|---|---|
| Y | LCO | 0 | 0 | 84.4 | 51.9 | 32.6 |

The results shown in Table 2 clearly demonstrate that Batteries A1 to A4 of the invention, in which the binder contained PAN, exhibited higher discharge rate ratios than that of Comparative Battery X1, in which the binder did not contain PAN, and that Batteries A1 to A4 exhibited substantially the same level of or higher discharge rate ratios than that of Comparative Battery Y, which employed LCO as the positive electrode active material.

The present invention is applicable to, for example, driving power sources for mobile information terminals such as mobile telephones, notebook computers, and PDAs, as well as power tools, power assisted bicycles, and HEVs.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

What is claimed is:

1. A non-aqueous electrolyte secondary battery comprising:
a negative electrode having a negative electrode active material capable of intercalating and deintercalating lithium; and
a positive electrode having a positive electrode mixture layer containing a positive electrode active material, a binder, and a conductive agent,
wherein the positive electrode active material comprises a layered lithium-transition metal composite oxide represented by the compositional formula LiₐNiₓM₍₁₋ₓ₎O₂ where 0<a≦1.1, 0.5<X≦1.0, and M is at least one element,
the binder contains a fluororesin and a nitrile-based polymer, and
the amount of the nitrile-based polymer is 40 mass % or less with respect to the total amount of the binder.

2. The non-aqueous electrolyte secondary battery according to claim 1, wherein the lithium-transition metal composite oxide is represented by the compositional formula LiₐNiₓM₍₁₋ₓ₎O₂ where 0<a≦1.1, 0.5<X≦1.0, and M is at least one element selected from the group including Co, Mn, Al, Mg, and Cu.

3. The non-aqueous electrolyte secondary battery according to claim 1, wherein the amount of the nitrile-based polymer is 8 mass % or greater with respect to the total amount of the binder.

4. The non-aqueous electrolyte secondary battery according to claim 1, wherein the amount of the nitrile-based polymer is 1 mass % or less with respect to the total amount of the positive electrode mixture layer.

5. The non-aqueous electrolyte secondary battery according to claim 2, wherein the amount of the nitrile-based polymer is 1 mass % or less with respect to the total amount of the positive electrode mixture layer.

6. The non-aqueous electrolyte secondary battery according to claim 3, wherein the amount of the nitrile-based polymer is 1 mass % or less with respect to the total amount of the positive electrode mixture layer.

7. The non-aqueous electrolyte secondary battery according to claim 5, wherein the amount of the nitrile-based polymer is 8 mass % or greater with respect to the total amount of the binder.

8. The non-aqueous electrolyte secondary battery according to claim 1, wherein the amount of the binder is 5 mass % or less with respect to the total amount of the positive electrode mixture layer.

9. The non-aqueous electrolyte secondary battery according to claim 2, wherein the amount of the binder is 5 mass % or less with respect to the total amount of the positive electrode mixture layer.

10. The non-aqueous electrolyte secondary battery according to claim 3, wherein the amount of the binder is 5 mass % or less with respect to the total amount of the positive electrode mixture layer.

11. The non-aqueous electrolyte secondary battery according to claim 4, wherein the amount of the binder is 5 mass % or less with respect to the total amount of the positive electrode mixture layer.

12. The non-aqueous electrolyte secondary battery according to claim 1, wherein the nitrile-based polymer is a polymer having a unit containing (meth)acrylonitrile.

13. The non-aqueous electrolyte secondary battery according to claim 2, wherein the nitrile-based polymer is a polymer having a unit containing (meth)acrylonitrile.

14. The non-aqueous electrolyte secondary battery according to claim 3, wherein the nitrile-based polymer is a polymer having a unit containing (meth)acrylonitrile.

15. The non-aqueous electrolyte secondary battery according to claim 4, wherein the nitrile-based polymer is a polymer having a unit containing (meth)acrylonitrile.

16. The non-aqueous electrolyte secondary battery according to claim 8, wherein the nitrile-based polymer is a polymer having a unit containing (meth)acrylonitrile.

17. The non-aqueous electrolyte secondary battery according to claim 12, wherein the nitrile-based polymer is polyacrylonitrile, and the fluororesin is polyvinylidene fluoride.
